(19) United States
(12) Patent Application Publication
(10) Pub. No.: US 2010/0215471 A1
(43) Pub. Date: Aug. 26, 2010

(54) RADIO BASE STATION LIFTING MACHINE

(76) Inventors: MATTHEW R. YOUNCE, SR., Marysville, CA (US); TIMOTHY SHELDON SPRINGSTEEN, Brownsville, CA (US); JAMES GORDON CRUMMETT, Browns Valley, CA (US)

Correspondence Address: JAMES G. CRUMMETT, 7168 WHITE OAK LANE, Browns Valley, CA, 95918, US

(21) Appl. No.: 12/380,252

(22) Filed: Feb. 24, 2009

(51) Int. Cl. B66C 3/00; H04W 4/00

(52) U.S. Cl. 414/785; 455/561

(57) ABSTRACT

The INVENTION is a machine and procedure which is used for installing, modifying, or removing electronic equipment which has been, or will be placed under cellular telephone Radio Base Stations (RBS). The INVENTION is secured to the RBS, and raises the RBS to a required height, allowing modifications. This INVENTION makes unnecessary the use of a helicopter, crane, fork-lift, boom truck, or other such engine-powered vehicle to raise and lower an RBS.

### BACKGROUND OF THIS INVENTION

In the cellular telecommunication (telecom) industry, electronics which make possible each two-way cell call are contained within an equipment box which is located in proximity to the transmission tower and antennae. An equipment box so utilized is referred to as a Radio Base Station (RBS). It is in the interest of vital communications and homeland security that these communication capabilities are continuously operational in the event of loss of local or regional electrical power. To preclude the disruption of communications in the event of electrical power loss, an additional cabinet which contains batteries may be placed beneath the RBS. Said added cabinet is called a Battery Back Up (BBU. Often there is a requirement to place different kinds of equipment or accessories under the RBS instead of a BBU. All of these under-cabinet modifications require the lifting of the heavy (up to 2000 pounds) RBS in order to place the BBU, or other equipment beneath the RBS. The nature of the field site determines the type of equipment needed for the lift, as well as the number of personnel, and the complex logistics required for these modifications. Historically and presently, these lifts have relied exclusively upon heavy, motorized equipment such as cranes and helicopters. An open field or property needs at least three personnel, and either a crane, boomtruck, or forklift. If there is significant snow on the ground, the crew cannot accomplish the task. An installation atop a high-rise building downtown requires a multitude of city permits, street barriers to block off the street below, traffic control, police or highway patrol, flagmen, a tall crane capable of reaching the top of the building, crane operator, and an installation crew atop the building. Sometimes, a cargo helicopter is needed with its attending crew and cost.

### BRIEF SUMMARY OF THIS INVENTION

This INVENTION's novelty is that a two or three man crew, transporting the disassembled INVENTION by hand-dollies or other means, can accomplish that which currently requires three to ten personnel and an armada of diesel-burning equipment and vehicles, along with a variety of city permits and high cost. In about 25-minutes, the crew easily can assemble the structural frame of this INVENTION into place around the RBS, connecting to the lifting points of the RBS, and tightly cinching a nylon cargo strap around the lower portion of the upper telescoping legs of the framework, and encompassing the RBS. It takes two minutes for this INVENTION to lift the RBS high enough to install, modify, or remove the equipment underneath the RBS. It takes two minutes for the RBS to be lowered by this INVENTION to the final resting height. This INVENTION can utilize on-site power, or it can be powered by a small portable power source. The amount of power used by an ordinary household microwave oven is approximately equal to that which is used by this INVENTION during the two minutes of lifting the RBS, and the two minutes of lowering the RBS. No power is required to maintain the RBS in the “lifted” position. For installations atop a building, the crew uses hand-dollies with rubber tires or other means to transport this INVENTION via elevator or stairs to the upper stories or rooftop. A typical RBS weighs less than 2000 pounds. This INVENTION weighs less than 1000 pounds, and is easily assembled or disassembled for installation or transport. This INVENTION is constructed of material of sufficient structural strength such that it can lift 4500 pounds or more; thus, this INVENTION provides a large safety factor. A built-in safety feature in the form of leg ratchets keep the frame from settling lower if power should fail. One embodiment of this INVENTION utilizes steel tubing, welded together for the framework, hydraulic pump and rams for the lifting of the telescoping portion, and an operator's control station. Alternative materials for the frame include, but are not limited to, carbon fiber or aluminum components, suitably bonded together to form the framework. Other means of power to lift the telescoping portion of the frame include, but are not limited to, (1) electric motors with ball-screw or lead-screw drives, (2) pneumatic devices, and (3) manual cranking. The typical types of RBS include, but are not limited to, the Ericsson model 2106.

### DETAILED DESCRIPTION OF THE PREFERRED EMBODIMENT OF THIS INVENTION

Referring to the drawings:

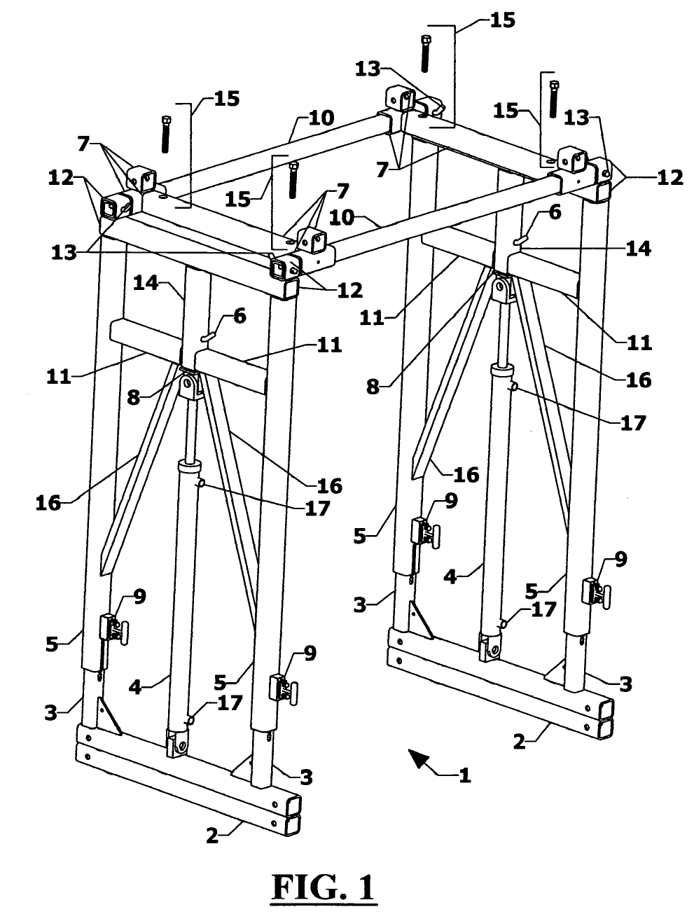

FIG. 1 is a perspective view of this INVENTION 1. Hydraulic rams 4 are an element in the preferred embodiment of the power system. In this embodiment, a hydraulic pump and hoses are connected to the hydraulic ports 17 and proper hydraulic fluid flows, raising or lowering the upper frame assembly 5-16. Note that lifting power also can be provided by electric motors and ball-screws and nuts, or by pneumatic devices, or by manual crank. Safety ratchet assemblies 9 are mounted on one or more telescoping outer legs 5. Footing 2 rests upon the ground, floor, or rooftop, and inner guide legs 3 provide guidance and stability as upper frame assembly 5-16 is lifted by rams 4. Telescoping outer legs 5 slide over inner guide legs 3 for a distance governed by the travel of ram 4 and by ram extension 8. Upper lift tubes 10 and slider bars 7 provide a secure platform for connection by a plurality of mounting bolts 15 to the lift-points of an RBS. The ends of upper lift tubes 10 slide into top receivers 12, and are secured by receiver latch pins 13. Horizontal braces 11 and angled braces 16 provide rigidity for upper frame assembly 5-16. Ram extension 8 can be made to slide in and out of ram extension guide 14, and can be fixed at a desired position by ram latch pin 6.

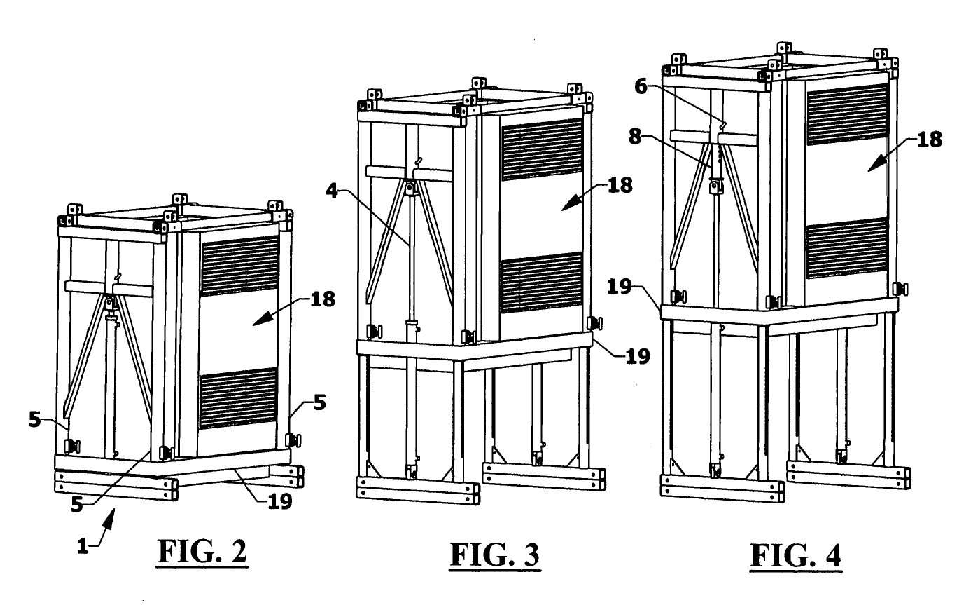

FIG. 2 represents this INVENTION 1 in one of many stages of lifting an RBS 18. In this view, the INVENTION 1 has been attached to an RBS 18, and is shown at base level before lifting. Nylon cargo strap 19 is tightly tensioned around RBS 18 and the lower portion of the telescoping outer legs 5, providing rigidity and stability during lift.

FIG. 3 shows the RBS 18 having been lifted to the full extension of the ram 4, along with nylon cargo strap 19.

FIG. 4 shows the RBS 18 having been raised an additional amount by the extension of ram extension 8, and secured in place by ram latch pin 6. Nylon cargo strap 19 continues to stabilize and make rigid the lifted assembly.

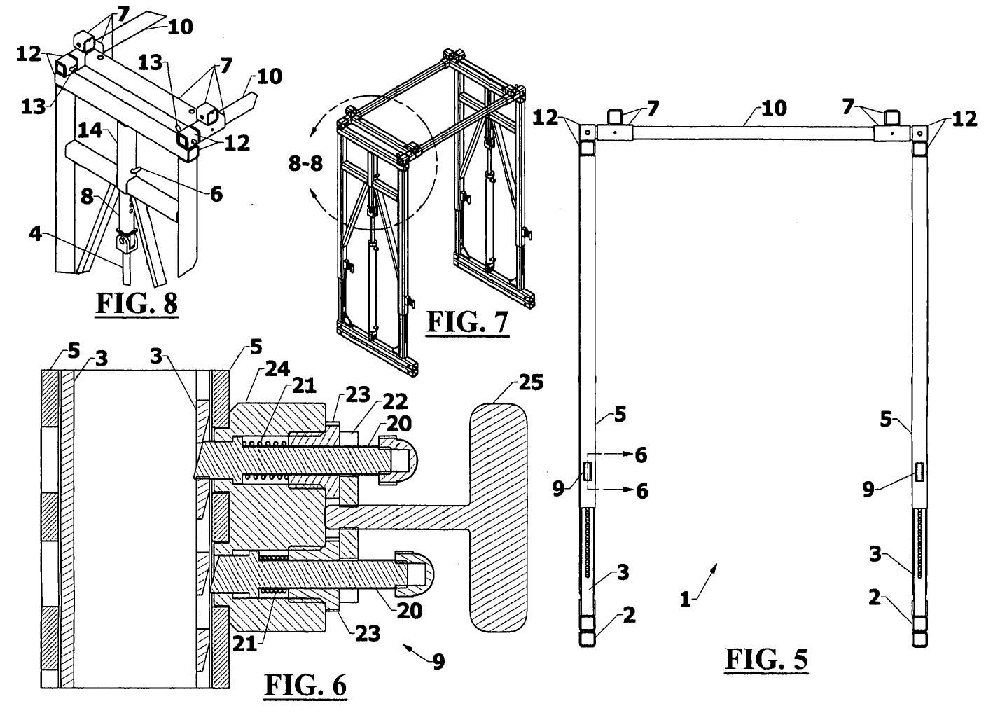

FIG. 5 is a front view of INVENTION 1, footings 2, inner guide legs 3, telescoping outer legs 5, upper lift tubes 10, slider bars 7, top receivers 12, and ratchet assemblies 9. Line 6-6 defines a section to be viewed in FIG. 6.

FIG. 6 is an enlarged detail section view of a single inner guide leg 3, telescoping outer leg 5, and associated ratchet assembly 9 substantially on the line 66 of FIG. 5; said ratchet assembly is permanently attached to the telescoping outer leg 5. Shown in this view are the ratchet knob 25, ratchet pins 20, springs 21, ratchet plate 22, ratchet pin nut 23, ratchet body 24, inner guide leg 3, and telescoping outer leg 5. The angular feature of the face of ratchet pin 20 engages the sloped exit hole in inner guide leg 3, allowing ratchet assembly 9 to move upward relative to inner guide leg 3, alternately compressing and releasing the springs 21 as the ratchet pins 20 alternate between snapping into, and then camming out of, the holes in inner guide leg 2. Should there be any undesirable descent of the system, one of the ratchet pins 20 of each ratchet assembly 9 will snap into a hole in inner guide leg 3, preventing any further downward movement. Ratchet knob 25 has a threaded shaft which engages mating threads in ratchet plate 22, and is used to extract both ratchet pins 20 out, and into a position which allows intentional lowering of the system.

FIG. 7 is a perspective view of one side of FIG. 5. Line 8-8 selects a portion to be examined in FIG. 8.

FIG. 8 is a detail view from line 8-8 of FIG. 7. Slider bar 7 can be positioned as desired along upper lift tube 10. When the end of upper lift tube 10 is inserted into top receiver 12, receiver latch pin 13 is inserted into the holes aligning top receiver 12 with upper lift tube 10 at the four corners. When the ram 4 has reached its fullest extension, further raising of the system can be achieved by ram extension 8, which can be slid in and out of ram extension guide 14, and fixed at the desired position with ram latch pin 6.

We claim:

1. A machine comprising:
a load-bearing, two-sided rectangular framework, each side being each constructed of a lower stationary portion, the footings of which rest upon the ground, rooftop, or floor, and an upper telescoping portion, the tops of which are joined rigidly together by a rectangular top structure; said rectangular top structure is capable of being rigidly attached to a cellular telephone Radio Base Station (RBS), said machine thus being capable, under the influence of an operator-controlled power system, of vertically raising or lowering an RBS,
a plurality of bolts which securely attach, either directly or indirectly, the adjustable upper structure of said framework to the lift-points of the RBS,
a nylon cargo strap tightly encompassing the RBS and the telescoping outer legs of the INVENTION, thereby greatly increasing stability and rigidity,
one or more sets of ratchets which are mounted on telescoping outer legs. Said ratchets contain one or more spring-loaded pins which can engage holes in inner guide legs, thus preventing unwanted lowering of the RBS.

2. A machine of claim 1, wherein said power system consists of a hydraulic pump, reservoir, hoses, valves, proportioning components, rams, and control circuitry.

3. A machine of claim 1, wherein said power system consists of electric motor(s), associated control circuitry, and drive mechanism(s) providing lifting and lowering of the machine. Said drive mechanism consists of a ball-screw/nut, or a lead-screw/nut, gears, or any combination thereof.

4. A machine of claim 1, wherein said power system consists of pneumatic lifters, which are powered by a compressor.

5. A machine of claim 1, wherein said power system consists of hand crank(s) and gearing.
